(19) United States
(12) Patent Application Publication
(10) Pub. No.: US 2024/0232917 A1
(43) Pub. Date: Jul. 11, 2024

(54) SYSTEMS, METHODS, AND SOFTWARE FOR ENHANCED POLLING TECHNIQUES

(71) Applicant: Microsoft Technology Licensing, LLC, Redmond, WA (US)

(72) Inventors: Shay BEN-ELAZAR, Herzliya (IL); Elad GRAIVER, Tel-Aviv (IL); Ori BAR-ILAN, Even Yehuda (IL); Yonatan TURKIN, Givatayim (IL); Brittany Dean HOLZWORTH, Denver, CO (US); Fadi ELIAS, Haifa (IL); Nadav ROSENTHAL, Modiin (IL); Angela Michelle LAMBERT, Bothell, WA (US); Tal KOREN, Haifa (IL)

(21) Appl. No.: 18/337,298

(22) Filed: Jun. 19, 2023

Related U.S. Application Data
(60) Provisional application No. 63/479,344, filed on Jan. 10, 2023.

(51) Int. Cl. G06Q 30/0203

(52) U.S. Cl. CPC G06Q 30/0203

(57) ABSTRACT

A computing apparatus comprising: one or more computer readable storage media, one or more processors operatively coupled with the one or more computer readable storage media, and program instructions stored on the one or more computer readable storage media that, when executed by the one or more processors, direct the computing apparatus to at least: receive an image of an emotions board, wherein the emotions board includes a canvas and response cards of group members arranged on the canvas in proximity to polling cards. For at least a response card of the response cards, the program instructions direct the computing device to identify a position of the response card on the canvas, identify an emotion corresponding to the position on the canvas, identify a group member associated with the response card, and log the emotion in association with the group member.

### RELATED APPLICATION

This application is related to, and claims the benefit of priority to, U.S. Provisional Patent Application No. 63/479,344, filed on Jan. 10, 2023, and entitled SYSTEMS, METHODS, AND SOFTWARE FOR ENHANCED LEARNING ENVIRONMENTS, which is hereby incorporate by reference in its entirety.

### TECHNICAL FIELD

Aspects of the disclosure are related to the field of computer software applications and services and to technology for enhanced polling techniques.

### BACKGROUND

Online polling software is a way to gather real-time feedback, data, and information from an audience via smartphone, online, and other tools. Polling tools can help users make more informed decisions, boost awareness, and increase engagement, while also automating the creation, management, and analysis of live polls.

Polling is one method of monitoring the social and emotional wellbeing of an audience such as a classroom, a team, or the like. With respect to educational settings, social and emotional learning (SEL) technology is a strengths-based, developmental field where software tools are employed to develop and expand social and emotional competency. Social and emotional skills (SES) include self-awareness, self-management, social awareness, relationship skills, and responsible decision-making.

In one solution that combines polling with SEL technology, students utilize a software application to indicate which emotion (e.g., happy, sad, scared, angry) they associate with on a specific day and time. The students' emotions may then be observed and analyzed on a per-student or group basis, providing useful insights to the teacher about student trends and areas in need of targeted teaching.

Such solutions, however, necessitate that the students have access to the relevant software and a suitable computing device on which to interact with the software. This is problematic because some schools lack the resources to provide software on a one-to-one basis, or limit access to devices as a policy. Even if such hurdles were overcome, deploying energy-intensive computers to collect relatively simple types of information (student emotions) may be excessive relative to the task at hand.

### OVERVIEW

Technology disclosed herein includes a solution that couples software and services with a physical manifestation of a poll, a vote, a survey, and the like to increase the efficiency and accessibility of polling processes. In an implementation, a software application on a computing device directs the device to receive a digital image of a physical polling board, wherein the polling board includes a canvas and response cards of group members arranged on the canvas in proximity to polling cards. For at least a response card of the response cards, the software application directs the computing device to identify a position of the response card on the canvas, identify a polling option corresponding to the position on the canvas, identify a group member associated with the response card, and log the polling option in association with the group member. Taken together, the logged polling option may be analyzed to generate insights, which may be delivered to a teacher, supervisor, survey/polling administrator, or the members themselves (e.g., to improve social and emotional skills).

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates a polling process in an implementation.

FIG. 3 an operational scenario in an implementation.

FIG. 4 illustrates a user interface in an implementation.

FIG. 5 illustrates a kit description card in an implementation.

FIG. 6 illustrates a set of polling cards in an implementation.

FIG. 7 illustrates a set of response cards in an implementation.

FIG. 8 illustrates an operational scenario in an implementation.

FIG. 9 illustrates a user interface in an implementation.

FIG. 10 illustrates a user interface in an implementation.

FIG. 11 illustrates a polling process in an implementation.

FIGS. 12A-D illustrate an operational scenario in an implementation.

FIGS. 13A-B illustrate an operational scenario in an implementation.

FIGS. 14A-B illustrates an operational scenario in an implementation.

FIG. 15 illustrates a computing system suitable for implementing the various operational environments, architectures, processes, scenarios, and sequences discussed below with respect to the other Figures.

### DETAILED DESCRIPTION

Technology disclosed herein is directed to increasing effectiveness and the efficiency of polling techniques (e.g., in social and emotional learning environments). The polling technology disclosed herein improves the computational processes required to at least track, share, analyze, and store data associated with survey/polling responses as compared to existing technological solutions.

In various implementations, a computer-implemented software solution is disclosed that digitizes physical poll responses by using computer vision and then maps the corresponding poll answers that are displayed in a dedicated physical space. In one embodiment, the poll is represented by an in-class, physical “Reflect” emotions board or wall, where students are encouraged to check-in with their social-emotional status by placing their response card under one of several possible named options (e.g., emotion categories). The teacher records their responses by taking a picture of the board and submitting it to be analyzed by a computer vision solution. The computer vision solution matches student response cards with a class roster using a preconfigured index. The teacher may review an outcome of the algorithm and make any corrections before submitting poll results. Results may be stored to provide the teacher with attendance, trend data, and insights on class social-emotional state patterns. In some implementations, the results may be integrated with an existing online version(s) of polls taken using polling software.

While reference is made herein to the student and teacher dichotomy, it may be appreciated that the disclosed technology applies as well to any type of user or group member, regardless of their position in a hierarchical or non-hierarchical relationship—if any. For example, employees may be polled on behalf of their employer, and their poll results viewed by their manager or other personnel in a position of authority. In another example, users who are peers of each other may participate in a poll and the results and insights shared with one or more of the peers. In yet another example, an individual may respond to polls as disclosed herein and consume results and insights on one's own, with respect to the data provided by the individual (if not the group). Still other combinations and variations of use cases are possible and may be considered within the scope of the present disclosure.

Implementations described herein employ a polling process on one or more computing devices that facilitates the observation and analysis of in-person, physical polling boards. Group members (e.g., students, employees, peers, respondents) are able to respond to an in-person survey/poll by placing a physical response card proximate to one of several possible polling options on a physical polling board. The polling options include a selection of choices for responding to a prompt. Examples of polling options include—but are not limited to—a plurality of emotions (e.g., for a prompt about feelings), a plurality of locations (e.g., for a prompt about meeting locations), a plurality of statuses (e.g., for a prompt about attendees' employment), a plurality of times/dates (e.g., for a prompt about availability), and the like. The polling options may be represented on physical cards (e.g., polling cards) similar to the response cards. Alternatively, the polling options may be permanently or semi-permanently integrated with the physical polling board via stencils, ink, pins, tape, or the like. A pollster (e.g., teacher, employer, peer, leader) records the responses by taking a picture of the board using a suitable camera app on a mobile computing device and submits the picture to a polling service. Alternatively, the pollster may capture the responses using a camera that is already present in the classroom, conference room, or other such setting.

The polling service employs a polling process to analyze the image to extract and log the reported responses of each of the group members. The polling process may be employed locally with respect to a user experience (e.g., on a user's device), remotely with respect to the user experience (e.g., on a server, in the cloud, or the like), or distributed between or amongst multiple devices. For example, a computing device that provides all or a portion of the polling service receives an image of a physical polling board. The physical polling board may include a canvas and response cards of group members arranged on the canvas in proximity to polling cards. The image may have been taken using a mobile phone, tablet computer, or other such device, and uploaded to the service. The computing device identifies a position of each of the response cards on the canvas and identifies a polling option that corresponds to the position on the canvas. The computing device then identifies a group member associated with the response card and logs the polling option in association with the group member.

Various technical effects that result from improving polling technology as disclosed herein may be apparent. For example, the techniques enable digitization of poll responses for observing, sharing, and analysis. The techniques also provide an inclusive experience that removes individual participant dependency on a device (and/or dependency on a logged-in account) capable of submitting poll responses. The use of multiple computer vision methods improves recall and reduces the impact of noisy images. In the aggregate, eliminating the need for group members to provide their poll responses individually via computing software and devices reduces demand for the energy and infrastructure required to support the applications. Additionally, the present technology increases the ease with which group members can report their responses and preserves their anonymity.

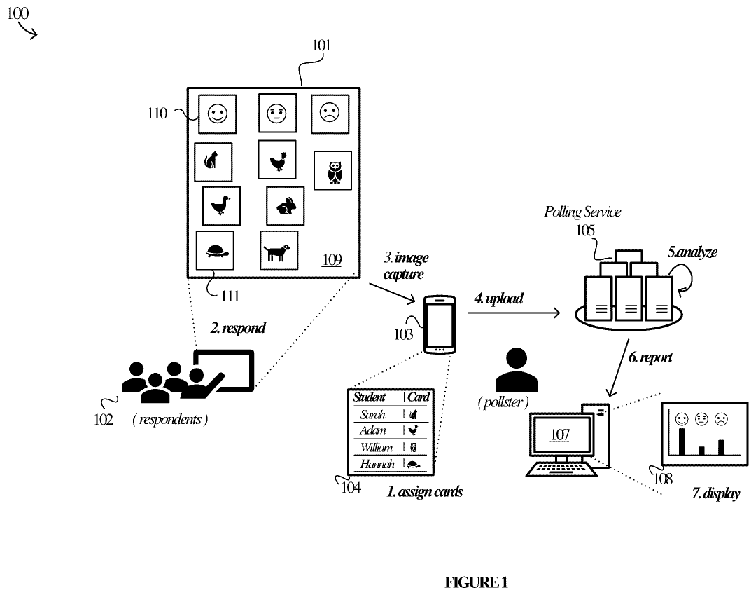

Referring to the Figures, FIG. 1 illustrates operational environment 100 in an implementation. Operational environment 100 includes physical polling board 101, computing device 103, computing device 107, and a polling service—referred to herein as service 105. Physical polling board 101 includes canvas 109 upon which response cards for group members are arranged in proximity to polling cards. An exemplary response to a polling question is a physical card that is attachable to canvas 109 (e.g., response card 111) and includes a graphical representation of a character, icon, image, and/or alphanumeric characters depicted on the surface of the card. The response cards may be made from paper, plastic, or other such material that separately or in conjunction with some other materials, adheres the symbols to canvas 109. Canvas 109 itself may be made of any substance or material to which the response cards adhere such as paper, plastic, slate, or the like. The cards may adhere to the canvas by virtue of their own properties (e.g., magnetism or static force), or via an intermediate substance such as tape or “hook and loop” technology.

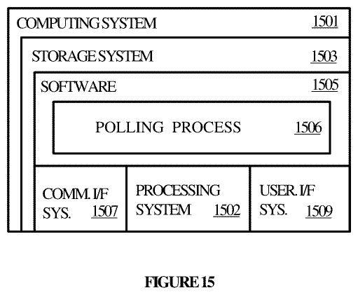

Computing devices 103 and 107 are each representative of a suitable computing device used by a pollster to interact with service 105. Examples of computing devices 103 and 107 include—but are not limited to—mobile phones, tablet computers, laptop computers, and desktop computers, of which computing device 1501 in FIG. 15 is representative. Computing device 103, which is depicted here as a mobile phone, includes one or more software applications capable of capturing an image of physical polling board 101 and uploading the image to service 105. Computing device 107, which is depicted here as a desktop computer, includes one or more software applications capable of obtaining insights or other such reports from service 105 related to the polling achieved by physical polling board 101. The features and functionality of computing devices 103 and 107, while illustrated here as distributed across two devices, may be integrated into a single device (e.g., just computing device 103).

Service 105 provides one or more computing services to end points such as computing devices 103 and 107. Service 105 employs one or more server computers co-located or distributed across one or more data centers connected to or otherwise in communication with computing devices 103 and 107. Examples of such servers include web servers, application servers, virtual or physical servers, or any combination or variation thereof, of which computing device 1501 in FIG. 15 is broadly representative. Computing devices 103 and 107 may communicate with service 105 via one or more internets and intranets, the Internet, wired and wireless networks, local area networks (LANs), wide area networks (WANs), and any other type of network or combination thereof.

Service 105 includes one or more software applications capable of receiving images from computing device 103, analyzing the images, and logging information extracted from the images. In addition to polling features and functionality, service 105 may optionally provide a suite of applications and services with respect to a variety of computing workloads such as social sharing, office productivity tasks, email, chat, voice and video, and so on. It may be appreciated that some of the features and functionality attributed to service 105 may be performed by computing devices 103 and 107 in some implementations.

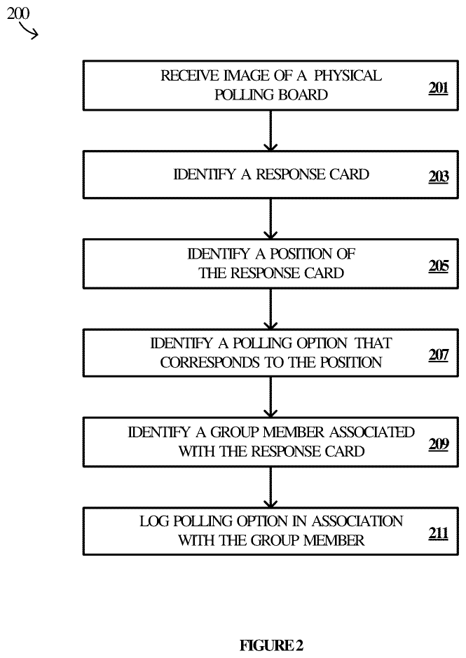

Service 105 employs a polling process to analyze image data, of which polling process 200 in FIG. 2 is representative. Polling process 200 may be implemented in program instructions in the context of any of the software applications, modules, components, or other such elements of service 105. The program instructions, when executed by one or more processors of one or more computing devices, direct the one or more computing devices to operate as follows, referring to a computing device in the singular for the sake of clarity.

In operation, a computing device employing polling process 200 receives an image of a physical polling board (step 201). The physical polling board includes a canvas upon which a member of a group can place a response card that includes a graphical representation of a character anonymously associated with the group member. (It may be appreciated that the group members need not always be represented anonymously; rather, it may be appropriate and/or desirable in some situations to provide non-anonymous associations of characters with group members.) For example, a student group member may be associated with a giraffe character, a parrot, or other such anonymous characters or symbols. In some implementations, the response card also includes alphanumeric characters corresponding to the graphical character. Other symbols are possible such shapes or patterns. For example, a user could be associated with a specific shape having a specific color, in which case the user's card would be depicted with the specific shape and color. In addition, an alphanumeric code may be printed on the card that identifies the shape and color, either explicitly or in an encoded format.

Next, the computing device employs computer vision to identify all of the response cards embedded or otherwise represented in the image (step 203). This step may include, for example, performing an object detection algorithm to detect any objects in the image shaped like a card and having content within the boundary of the card representative of any possible graphical characters, symbols, or the like. In addition, the computing device may analyze the content within each card boundary to identify any alphanumeric characters that identify the graphical character or symbol. For instance, the computing device may perform optical character recognition with respect to the content within the boundaries of each of the cards to identify letters and/or numbers that identify the graphic character or symbol on the card (e.g., to extract information such as the name of a character, emotion, polling option).

In some implementations, polling cards on the canvas may also be identified in the same or a similar manner as the response cards. Alternatively, the identification of the polling cards may be known a-priori such that their presence need not be detected. For instance, in some implementations the content of the polling cards may be integrated into the canvas of the physical polling board, rather than utilizing physical cards to represent polling options.

Having identified the cards in the image, the computing device identifies a position of each of the response cards in the image (step 205). For example, the computing device may determine the position of a given card in terms of x-y coordinates in the image. The x-y coordinates may be relative with respect to the image itself. Alternatively, the x-y coordinates may be relative to polling cards on the physical polling board, relative to the response cards with respect to each other (e.g., overlapping), or relative to known locations on the physical polling board that correspond to dedicated locations of the emotions.

Next, the computing device identifies a polling option that corresponds to the identified position (step 207). For example, the computing device identifies the polling card having the closest proximity to the response card on the canvas. Alternatively, the computing device may identify the polling card that resides within a particular region associated with the response card. The computing device then determines which polling option is associated with the identified polling card. Alternatively, if depictions of the polling options are integrated into the physical polling board (e.g., painted on the canvas rather than represented via cards), then the computing device identifies the polling option depiction closest to the response card. Additionally, the computing device may create virtual borders based on the locations of the polling cards, where the borders indicate response affinity regions for the named polling options. A response card may be mapped to an affinity region based on the response card's identified position within, or proximate to, a given affinity region.

Proximity may be determined by calculating a distance in the image from a given response card to each of the polling cards (or depictions of the polling options) and evaluating the resulting proximity values against each other, for example, to identify the polling card most proximate to the response card. In some implementations, a centroid is determined for each response card and each polling card. The resulting centroids, which may be corrected to account for distortions in the image, are then used to calculate the distance between two cards.

In the same or other implementations, polling cards may be placed in multiple horizontal or vertical rows on a physical polling board, in which case a directional filter may be applied when determining proximity. For example, in a situation where polling cards are arranged in two horizontal rows on a physical polling board (one row above the other row), group members place their response cards in a generally vertical direction below a chosen polling option. As such, when proximity is determined, polling cards falling below a given response card may be filtered out, meaning that only polling cards above the response card are valid candidates.

Likewise, in a situation where polling cards are arranged in two vertical rows on a physical polling board (one row next to the other row), group members place their response cards in a generally horizontal direction with respect to a chosen polling option (e.g., to the right of a chosen polling option). As such, when proximity is determined, polling cards to the right of a given response card may be filtered out, meaning that only polling cards to the left of response cards are valid candidates.

It may be appreciated that the response cards in some implementations do not include information that identifies the group member who placed the card on the canvas, thereby preserving the anonymity of the group member. However, in situations where the pollster desires to observe trends on a per-member basis and/or to gain insights and information about a specific member, the computing device performs a look-up in a table that has the identities of the group members stored in association with response cards. The computing device identifies a group member associated with a given response card by searching for the name of the graphical character or symbol depicted on a given response card (step 209). As mentioned, the character name may be represented in alphanumeric text in an encoded or unencode format on the surface of each of the response cards. Accordingly, the computing device retrieves the identity of the group member on this basis and proceeds to log the determined polling option in association with the group member (step 211). The polling option is logged with a date stamp so that, over time, a historical record of the member's reported responses can be analyzed (e.g., in furtherance of the member's social and emotional learning).

In some implementations, the computing device may access the log to generate a user interface that includes insights on trend data. The trend data may include analysis of an individual group member or a composite of all members of the group. Examples of trend data include changes in responses that are associated with one or more group members, comparisons of responses that are associated with a group member when a task is assigned or performed, comparisons of responses associated with a group member on a day of the week, and the like.

Referring back to FIG. 1, the following describes an application of polling process 200 with respect to the elements of operational environment 100. Physical polling board 101 includes three polling cards already attached to the canvas (e.g., polling card 110). Each polling card depicts a different emotion as indicated by the graphical representations of different emotions. Here, a happy emotion is represented by a happy face, a neutral emotion is represented by a neutral face, and a sad emotion is represented by a sad face. Any number of emotions are possible in addition to those disclosed herein such as confusion, excitement, stress, surprise, anger, fear, and the like.

In operation, a pollster (e.g., a teacher) assigns a unique response card to each group member (e.g., student) of respondents 102. The members' response cards each depict a particular animal, shape, alphanumeric graphic, or other such symbolic representation associated with the respective member. For instance, response card 111 depicts an image of a turtle, whereas others of the cards depict a cat, an owl, and so on. Using the animals to represent the members preserves their anonymity when an image of the board is captured and uploaded to service 105.

The pollster, using computing device 103, records the associations of members and their respective response cards. Here, the associations are recorded in table 104, which has a column for the names of the members (i.e., identities of group members) and a column for the response cards assigned to the members. Though not shown, the pollster may use computing device 103 to upload table 104 to service 105.

When respondents 102 are in possession of their response cards, they physically attach the response cards to physical polling board 101. For example, each student approaches the board with their respective response card and places the card on the board such that its position generally aligns with or otherwise is indicative of the student's present emotion. Here, a student has placed response card 111 in the same column as polling card 110 to indicate that the student is feeling happy. Once respondents 102 finish placing their response cards on the board, the teacher takes a picture of physical polling board 101 using computing device 103 to capture the image. The pollster then uploads the captured image to service 105.

Service 105, employing a polling process with respect to the uploaded image, identifies the members' response cards and their corresponding polling options. Service 105 then logs the identified polling options in association with the respective members. Service 105 may generate insights by analyzing the polling options logged in association with one or more of the members. Examples of insights include—but are not limited to—attendance of the members, trends of the members' polling options, patterns of polling options (e.g., most frequently selected polling option), distributions of polling options (e.g., number of times each polling option was associated with one or more members), and the like. Service 105 may generate a report that includes the insights and transmits the report to computing device 107 for display in user interface 108.

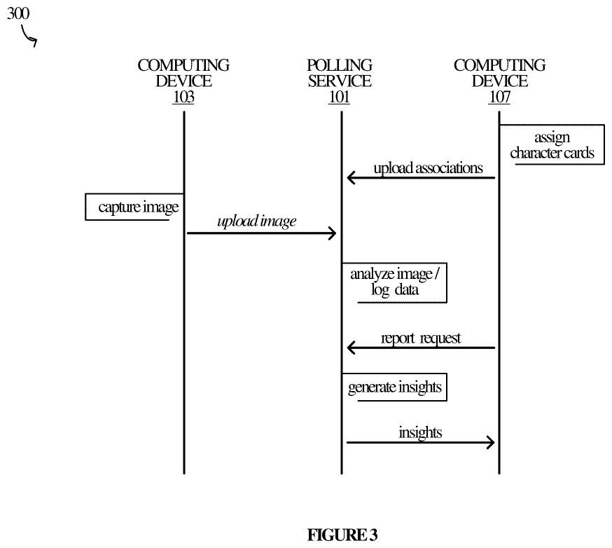

FIG. 3 illustrates a brief operational scenario 300 in an implementation in which the pollster, via computing device 107, makes associations between response cards and one or more members by assigning character cards to the members. Using computing device 107, the pollster then transmits the associations to service 105, which receives and logs the associations.

Next, the pollster, using computing device 103, captures an image of a physical polling board and transmits the digital image data to service 105, which in turn receives and analyzes the image data. The analysis of the image data includes service 105 employing a polling process to identify associations between response cards and polling cards and to log the identified associations.

Using computing device 107, the pollster then requests from service 105 a report that details insights of the logged polling options. Responsive to the request, service 105 generates insights based on the associations between response cards and polling cards. The insights are incorporated into a report, which is transmitted by service 105 to computing device 107 for display in a user interface.

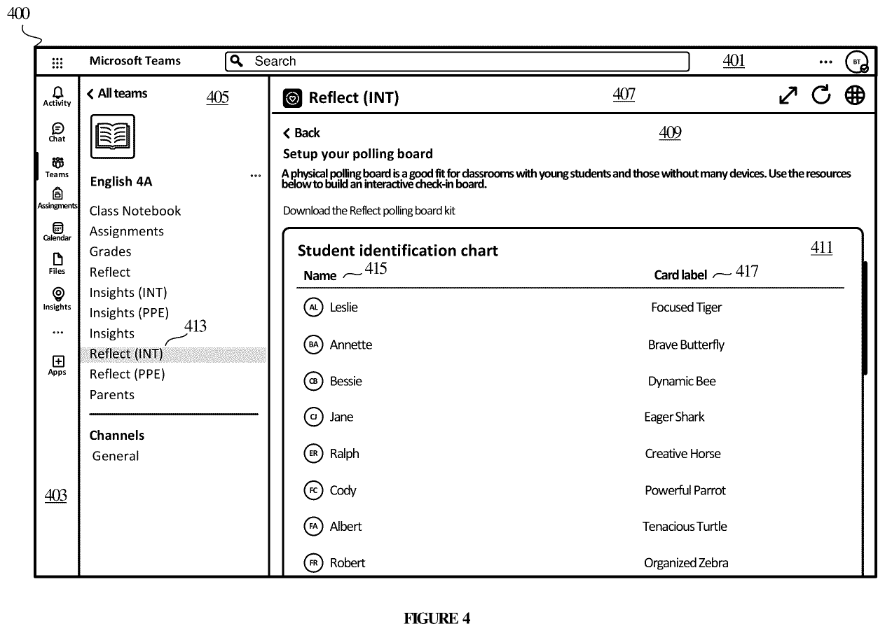

FIG. 4 illustrates user interface 400 in an implementation that is representative of a teacher-centric user experience. User interface 400 is representative of user interface to an application running on one or more of the computing devices discussed herein (e.g., computing devices 103 and 107). User interface 400 includes title bar 401, menu 403, and panel 405. Menu 403 provides a user with access to various modules of the application including an activity module, a chat module, a team module, a calendar module, a files module, and an insights module. Panel 405 displays features and functionality related to a selected one of the modules in menu 403. Here, it is assumed for exemplary purposes that a user has selected the team module. As such, panel 405 includes elements for navigating to features or applications of the team modules. Examples include a class notebook application, an assignments application, a grades application, an insights application, and a reflect application.

A user may select any of the applications to access their corresponding features and functionality through user interface 400. For example, it is further assumed for exemplary purposes that the user has selected the reflect application via element 413. A teacher may use the Reflect application to configure or otherwise setup a physical polling board (e.g., an emotions board) in the context of a classroom. Selecting element 413 causes user interface 400 to display a title bar 407 for the Reflect application, a main page 409 for the Reflect application, and a configuration panel 411.

Configuration panel 411 includes a student column 415 and a label column 417. Student column 415 lists by name all of the students in a classroom. Label column 417 lists by name the character labels associated with the students. For instance, Leslie has been assigned the Focused Tiger label. In the physical classroom, the teacher has given Leslie a response card that depicts an image of the Focused Tiger character. Similarly, Annette has been assigned the Brave Butterfly response card, and so on for the remainder of the class. The teacher may interface with configuration panel 411 when assigning the character labels to the students. The associations setup via configuration panel 411 may be stored in a table, list, graph, or other such data structure utilized by a polling service to facilitate the observing, sharing, and analyzing of student responses.

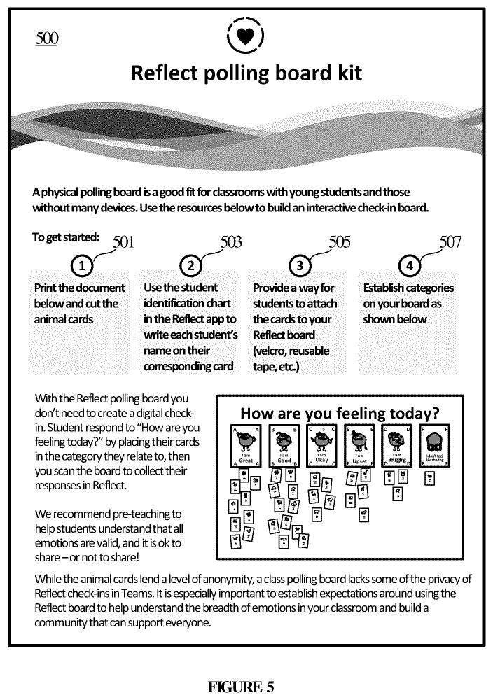

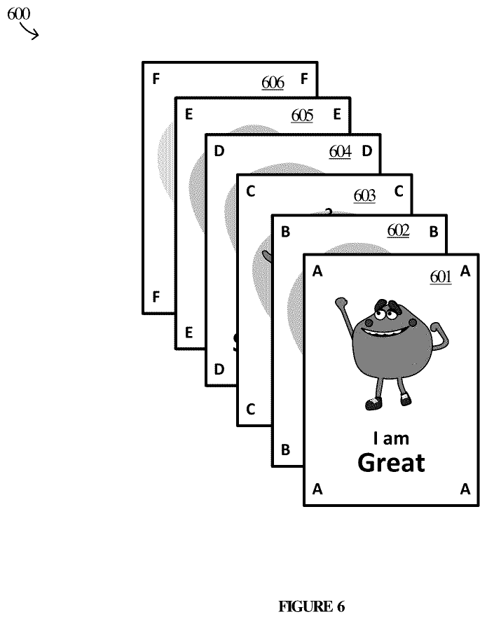

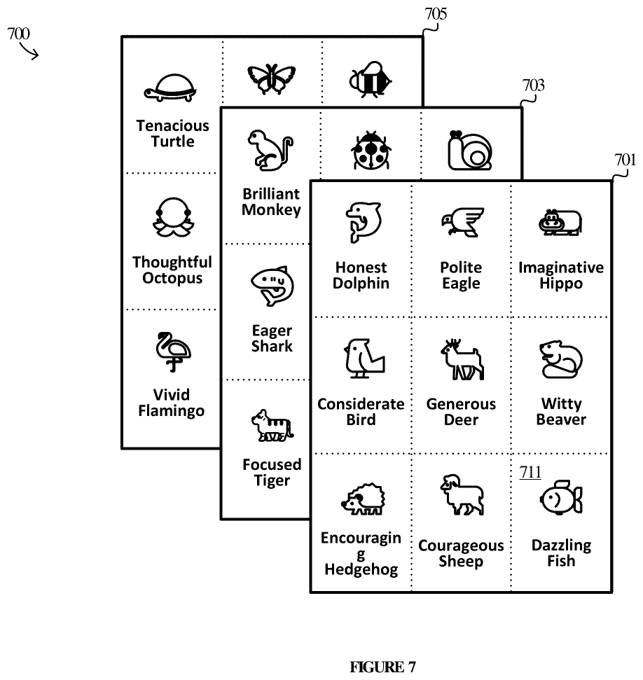

FIG. 5 illustrates kit card 500 in an implementation that is representative of a teacher-centric user experience. Kit card 500 is representative of printed content which may be provided to a teacher (or other pollster) with step-by-step instructions for implementing an interactive polling board as disclosed herein. Kit card 500 may be accompanied by a set of polling cards and a set of response cards in a pre-printed or printable package, examples of which are provided below with respect to FIG. 6 and FIG. 7.

Kit card 500 describes at step 501 a teacher printing response cards, and at step 503, the teacher is making associations between the response cards and the students by assigning the cards to students and recording the assignments. At step 505, the teacher is to provide a means for attaching the response cards to a physical polling board (e.g., using “hook and loop” technology, tape). Finally, at step 507, the teacher is instructed to create columns on the physical polling board for the emotion categories (e.g., polling options), which the students use to report on their feelings by attaching the response cards below or in proximity to the corresponding emotion category.

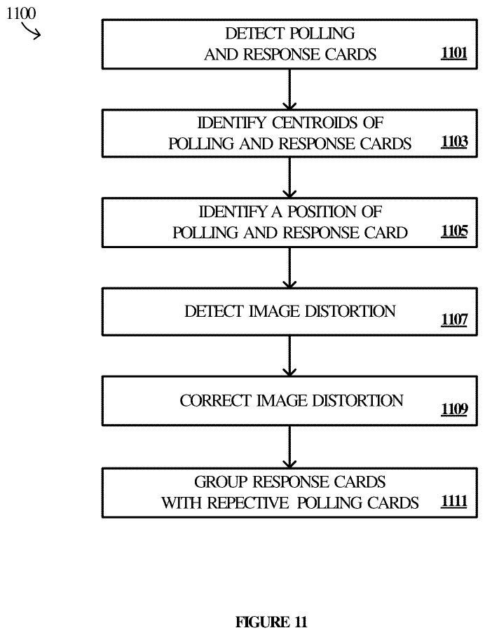

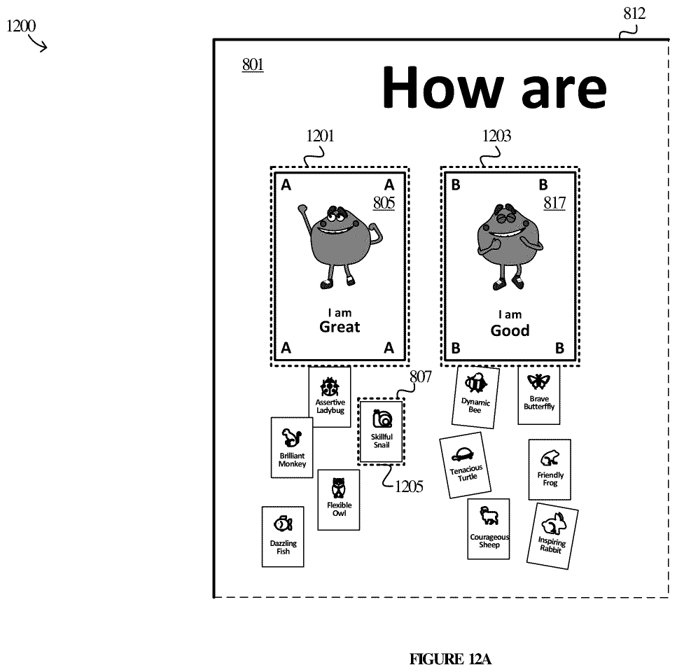

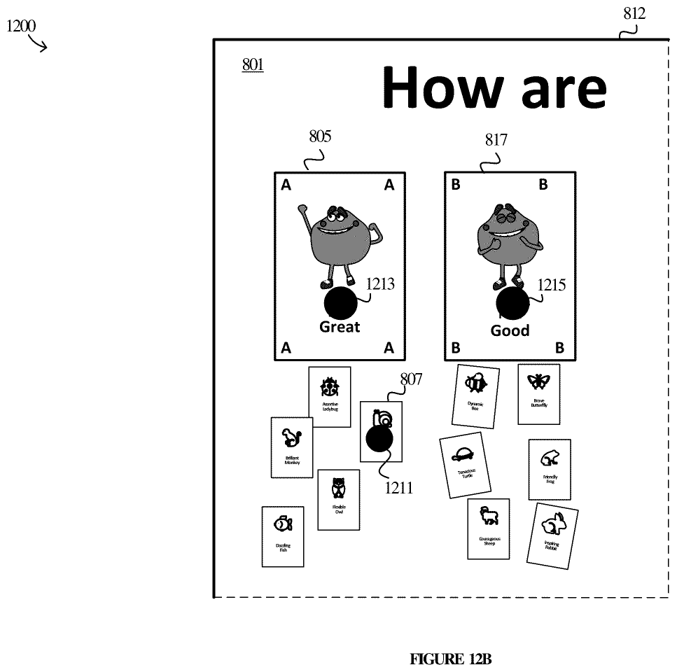

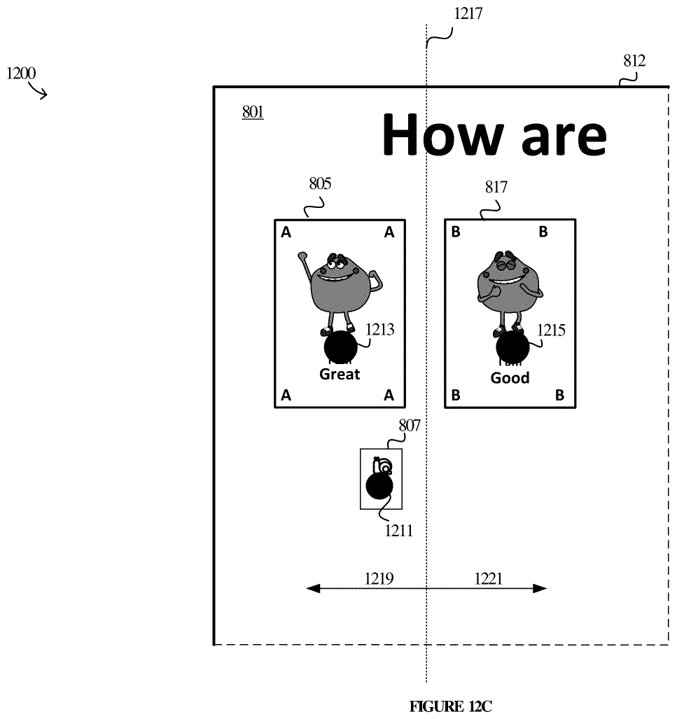

FIG. 6 illustrates a set 600 of polling cards in an implementation. Set 600 includes polling cards 601-606, which are depicted here as physical cards each containing a depiction of an emotion (e.g., polling option). For example, polling card 601 depicts a happy emotion by portraying an image of a character that is smiling and having the name “I am great”. Each polling card also includes alpha-numeric anchor points positioned at the corners of the card. The anchor points may be used to identify and correct image distortion as discussed in more detail below with respect to FIGS. 11-14B.

In an implementation, a pollster (e.g., teacher) places or otherwise attaches polling cards 601-606 on a physical polling board (e.g., an emotions board). Group members may then reference the position of polling cards 601-606 on the physical polling board to determine where to place their respective response cards. Though polling cards 601-605 are described as physical cards that are to be attached to a physical polling board, it is contemplated herein that the depiction of the emotion may be otherwise physically integrated with the physical polling board by methods that include—but are not limited to—inking, painting, drawing, and the like.

FIG. 7 illustrates a set 700 of response cards in an implementation. Set 700 includes sheets 701, 703, and 705 from which individual response cards may be cut. For instance, sheet 701 includes response card 711, which depicts the unique graphic of a fish and the name “Dazzling Fish.” In an implementation, a pollster (e.g., teacher) separates the response cards by cutting or slicing sheets 701-705 to generate individual response cards. The pollster may then provide one response card to each member of the group such that each group member has a unique response card to place on a physical polling board.

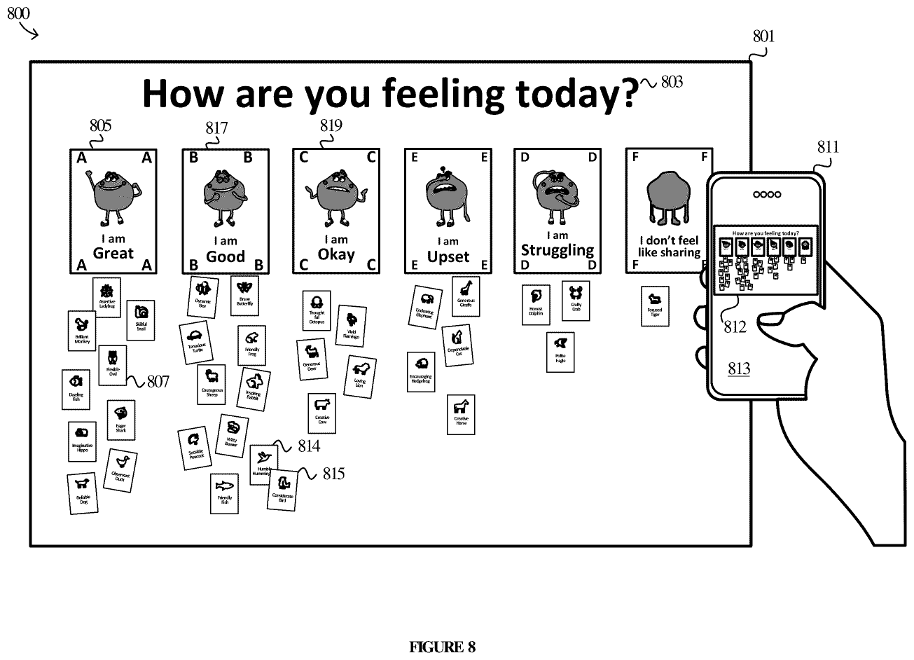

FIG. 8 illustrates operational scenario 800 in which a pollster takes a photograph of physical polling board 801 using a suitable camera application on mobile computing device 811. Physical polling board 801 is representative of a physical polling board and includes prompt 803, which asks group members to respond to the question “How are you feeling today?” Polling cards (e.g., polling card 805) are located beneath prompt 803 and provide the group members with options for responding to the prompt. For example, a member may respond to the prompt by attaching response card 807 under polling card 805 to indicate that they are feeling “great”.

Here, the pollster is using mobile computing device 811 to capture image 812, as seen on display screen 813. The pollster then uses mobile computing device 811 to upload image 812 to a polling service for analysis and logging. After the pollster uploads image 812, the polling service employs a polling process to determine the relative locations of the response cards with respect to the polling cards. For example, the polling service determines whether response cards 814 and 815 correspond to the “good” emotion or the “okay” emotion.

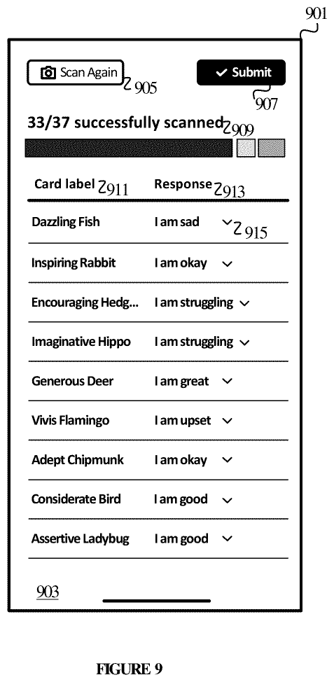

FIG. 9 illustrates mobile display screen 901 in an implementation. Mobile display screen 901 may belong to one or more of the computing devices discussed herein (e.g., computing devices 103 and 107). Mobile display screen 901 includes user interface 903, which may be generated by an application running on the one or more computing devices discussed herein. A user may interact with user interface 903 to access the polling technology disclosed herein. For example, a pollster may utilize user interface 903 to access a report that contains insights generated by a polling service (e.g., service 105) that analyzed an image of a physical polling board. Here, user interface 903 provides access to a report that details the results of associations between response cards and polling cards that were identified by a polling service. The report may be edited, if necessary, and then submitted using user interface 903.

User interface 903 includes elements 905, 907, and 909 and columns 911 and 913. Element 905 is selectable to recapture the image of the emotions board, and element 907 is selectable to submit the report (e.g., for storing, for sharing, for further analysis). Element 909 indicates the success rate of the mapping performed by the polling service for the current prompt. Column 911 includes a list of the response cards (e.g., Dazzling Fish) associated with group members, and column 913 includes the polling option (e.g., “I am sad”) that was identified by the polling service as being associated with the response card. If the pollster determines that the polling service has made an error and misreported a member's response, the pollster may use element 915 of column 913 to alter the response. The polling service may then update element 909 to reflect the altered success rate.

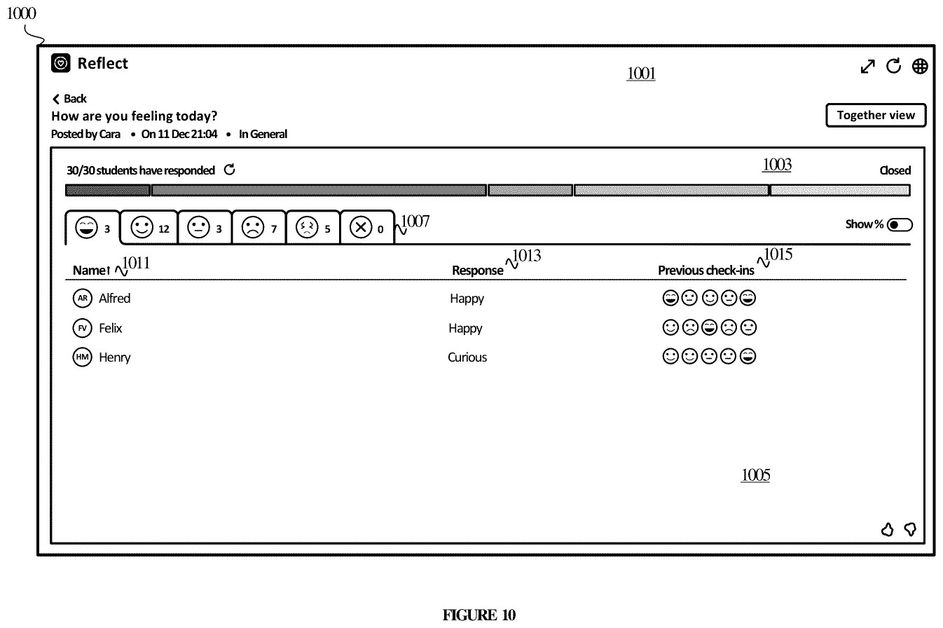

FIG. 10 illustrates a user interface 1000 which may be generated by an application running on one or more of the computing devices discussed herein (e.g., computing devices 103 and 107). A user may interact with user interface 1000 to access the polling technology disclosed herein. For example, a pollster may utilize user interface 1000 to access a report that contains insights generated by a polling service (e.g., service 105) that analyzed one or more images of physical polling boards. Here, user interface 1000 provides access to a report that details the responses identified for multiple group members by a polling service in response to the prompt “How are you feeling today?”.

User interface 1000 includes application interface 1001 and summary section 1003. Summary section 1003 indicates that all of the group members (i.e., students) have provided responses to the prompt and that the polling is closed. Additionally, summary section 1003 provides tabs 1007, which are selectable to transition view 1005 between individual summaries of each polling option (e.g., emotions). For each polling option, view 1005 includes columns 1011-1015. Column 1011 provides the names of the group members, column 1013 provides the responses that were associated by a polling service with the respective group member, and column 1015 displays the responses previously associated by the polling service with the respective group member.

FIG. 11 illustrates image correction process 1100 in an implementation. Image correction process 1100 is a process that may be employed in the context of a polling service (e.g., service 105). In some implementations, image correction process 1100 may be a sub-process of a polling process (e.g., polling process 200). Image correction process 1100 accommodates or otherwise accounts for shifts in perspectives created by taking a photo of a physical polling board from off-center angles as well as for correcting inaccuracies in the placement of polling cards. Image correction process 1100 may be implemented in program instructions in the context of any of the software applications, modules, components, or other such elements disclosed herein (e.g., in the context of service 105). The program instructions, when executed by one or more processors of one or more computing devices, direct the one or more computing devices to operate as follows, referring to a computing device in the singular for the sake of clarity.

In operation, a computing device employing image correction process 1100 detects polling cards and response cards in an image (step 1101). This step may include, for example, performing an object detection algorithm to detect any objects in the image shaped like a card and having content within the boundary of the card representative of any possible graphical characters, symbols, or the like. In addition, the computing device may analyze the content within each card boundary to identify any alphanumeric characters that identify the graphical character or symbol. For instance, optical character recognition may be performed with respect to the content within the boundaries of each of the cards to identify letters and/or numbers that identify the graphic character or symbol visually illustrated on the card (e.g., to extract information such as the name of a character, emotion, polling option).

Having detected the polling cards and the response cards, the computing device identifies a centroid for each of the detected cards (step 1103). This step may include any of the techniques discussed with reference to step 1101. For example, the computing device may perform optical character recognition, an object detection algorithm, or the like, to detect an object, text, boundary, etc. of a polling card or response card. The computing device may then assign a centroid to the detected object, text, boundary, etc. For example, a centroid may be identified at the location of a first letter of a word, the first word of a phrase, the middle of a word, phrase or graphic, the middle of the card, etc. Alternatively, multiple points may be identified on each card and the centroid calculated based on the location of each point.

Next, the computing device identifies a position of each of the polling cards and response cards in the image (step 1105). For example, the computing device may determine the position of a card's centroid in terms of x-y coordinates of the image. The x-y coordinates may be relative with respect to the image itself. Alternatively, the x-y coordinates may be relative to the identified centroids of the cards detected in the image, or relative to known locations on the physical polling board that correspond to dedicated locations (e.g., of anchor symbols, polling cards), and the like.

Having computed the centroids, the computing device detects distortion in the image (step 1107). Examples of image distortion include—but are not limited to—orientation (e.g., portrait, landscape), perspective distortions associated with the angle of the image recording device (e.g., camera, phone, tablet) relative to the physical polling board, misalignment of polling cards, and the like. The computing device may detect the image distortion by locating anchor symbols in the image and comparing a distance, angle, or both, between the anchor symbols of the image to known distances and/or angles of the anchor symbols on the physical emotions board. For example, polling cards may include two or more anchor symbols with distances and angles that are known a-priori. The computing device may identify the anchor symbols on the polling cards of the image and calculate a distance between the anchor symbols of the image. The computing device then compares the calculated distance to the known distance of the anchor symbols on the physical polling cards and detects an image distortion when the calculated distance differs from the known distance. Alternatively, the computing device may calculate an angle between the anchor symbols of the image, compare the calculated angle to the known angle of the anchor symbols on the physical polling cards, and detect an image distortion when the calculated angle differs from the known angle.

As image distortion may result in inaccurate identification of relative locations of polling cards and response cards within the image, the computing device corrects the detected image distortion by modifying aspects of the image (step 1109), thereby obtaining greater accuracy. The computing device corrects orientation distortions by reassigning x-y coordinates based on whether the image was recorded in a portrait perspective or a landscaped perspective, rotating the image on the x-y plane prior to assigning x-y coordinates, and the like. In another implementation, the computing device uses anchor symbols located on the physical polling board to correct perspective distortions. For example, an image may be reshaped, including the centroids of the polling cards and the response cards, to align the distance and/or angle of the anchor symbols of the image with the known values of the anchor symbols on the physical polling board.

Similarly, anchor points may be used to correct misalignment of a polling card. For example, a computing device may manipulate aspects of an image to align anchor points located on two or more polling cards. Alternatively, misalignment may be corrected using a regression line to project collinearity between the centroids of misaligned cards. For example, if polling cards are placed out of alignment on the physical polling board, a regression line may be projected based on the location of the centroids of the polling cards and used to alter the image such that the polling cards are aligned and their respective response cards repositioned accordingly. Though only a few exemplary corrections were discussed with reference to correcting image distortion, other corrective solutions are possible and contemplated herein.

Finally, the computing device groups the response cards with their respective polling cards (Step 1111). Specifically, the computing device groups a response card with a polling card having a centroid that is located above, and in closest proximity to, a centroid of the response card. When image distortions are corrected, the computing device uses the modified image to group the response cards with their respective polling cards. In an embodiment, the computing device creates virtual borders based on the locations of the centroids of the polling cards, where the borders indicate response affinity regions for the respective polling cards. A centroid of a response card may be grouped with a respective polling card based on the location of the centroid being within, or proximate to, a given affinity region.

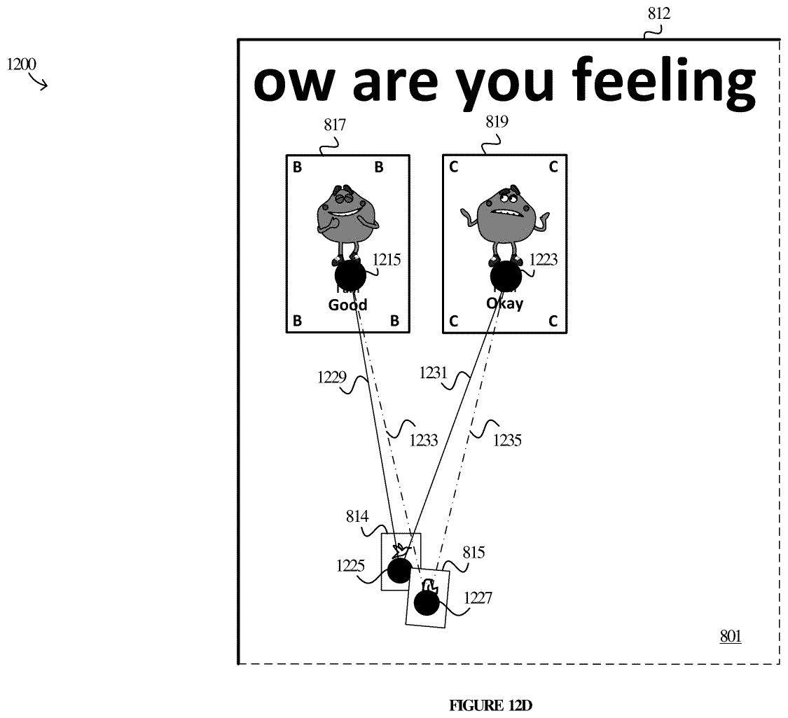

FIGS. 12A-12D illustrate brief operational scenario 1200 in an implementation in which a polling service (e.g., service 105) employs image correction process 1100 to analyze image 812 taken in FIG. 8 of physical polling board 801. The following describes an application of image correction process 1100 with respect to the elements of operational scenarios 1200A-D.

In FIG. 12A, operational scenario 1200 includes a portion of image 812 that depicts polling cards 805 and 817 and several of the response cards (e.g., response card 807) on a canvas of physical polling board 801. Here, a computing device detects polling cards 805 and 817, and response card 807, as illustrated by detection outlines 1201, 1203, and 1205, respectively. The computing device uses optical character recognition to detect polling cards 805 and 817 and response card 807. In another implementation, the computing device detects polling cards 805 and 817, and response card 807, by performing an object detection algorithm to find objects in image 812 shaped like a card or having content within the boundary of the card representative of possible graphical characters, symbols, etc.

In FIG. 12B, operational scenario 1200 also includes the portion of image 812 that depicts polling cards 805 and 817 and several of the response cards (e.g., response card 807) on the canvas of physical polling board 801. After detecting polling cards 805 and 817 and response card 807, the computing device identifies a centroid for each of the detected cards. For example, centroid 1211 was identified for response card 807, centroid 1213 was identified for polling card 805, and centroid 1215 was identified for polling card 817. Here, the computing device identified the respective centroids by detecting the text of the individual cards (e.g., centroids 1213 and 1215 are located over the phrase “I am”).

In FIG. 12C, operational scenario 1200 also includes the portion of image 812 that depicts polling cards 805 and 817 on the canvas of physical polling board 801, and for clarity, only one of the response cards (i.e., response card 807). After identifying centroids 1211-1215, the computing device further identifies a position of centroids 1211-1215. In this embodiment, the computing device determines the position of centroids 1211-1215 based on the x-y coordinates of image 812. Next, the computing device creates virtual border 1217 (e.g., based on the x-y coordinates of centroids 1213 and 1215), which separates affinity area 1219 from affinity area 1221. Since centroids 1211 and 1213 are located to the left of virtual border 1217, the computing device further identifies the positions of centroids 1211 and 1213 as within affinity area 1219. Because centroid 1215 is located to the right of virtual border 1217, the computing device further identifies the position of centroid 1215 as within affinity area 1221.

FIG. 12D illustrates an alternative to FIG. 12C. In FIG. 12D, operational scenario 1200 includes the portion of image 812 that depicts polling cards 817 and 819 on the canvas of physical polling board 801, and for clarity, only two of the response cards (i.e., response cards 814 and 815). In this alternative, the computing device identifies a position of polling cards 817 and 819 and response cards 814 and 815 by calculating the distance between their respective centroids (e.g., distances 1229-1235) to determine proximity. Specifically, centroid 1225 of response card 814 is located at a first distance 1229 from centroid 1215 and a second distance 1231 from centroid 1223. Distance 1229 is shorter than distance 1231. As a result, the computing device groups response card 814 with polling card 817, which has the closest proximity to response card 814.

Additionally, centroid 1227 of response card 815 is located at a first distance 1233 from centroid 1215 and a second distance 1235 from centroid 1223. Distance 1233 has the same value as distance 1235. As a result, the computing device searches for centroids of response cards that are proximate to centroid 1227 to determine with which emotion response card 815 should be group. Here, response card 815 overlaps response card 814, and the computing device determines centroid 1225 has the closest proximity to 1227. Therefore, the computing device groups centroid 1227 with centroid 1225, and by extension, groups response card 815 with the same polling card as response card 814 (i.e., polling card 817).

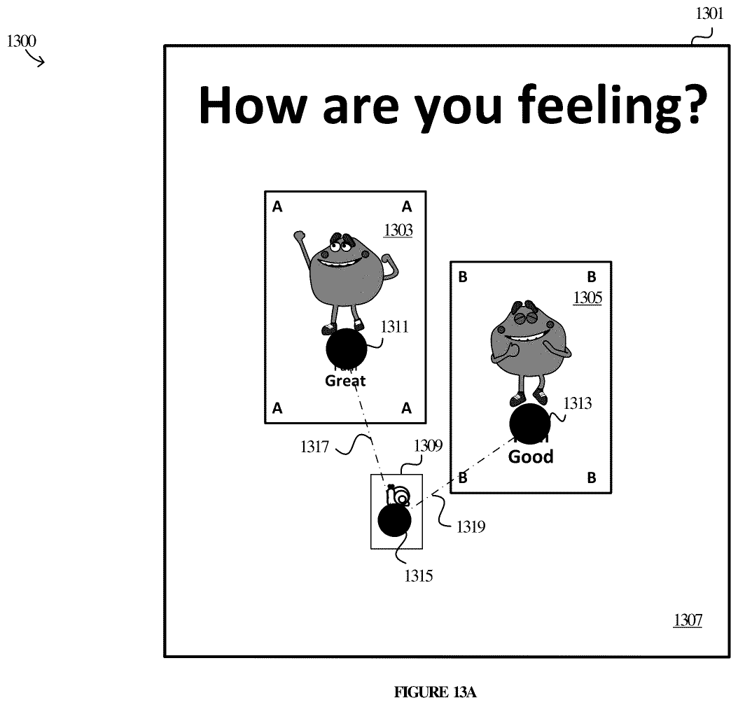

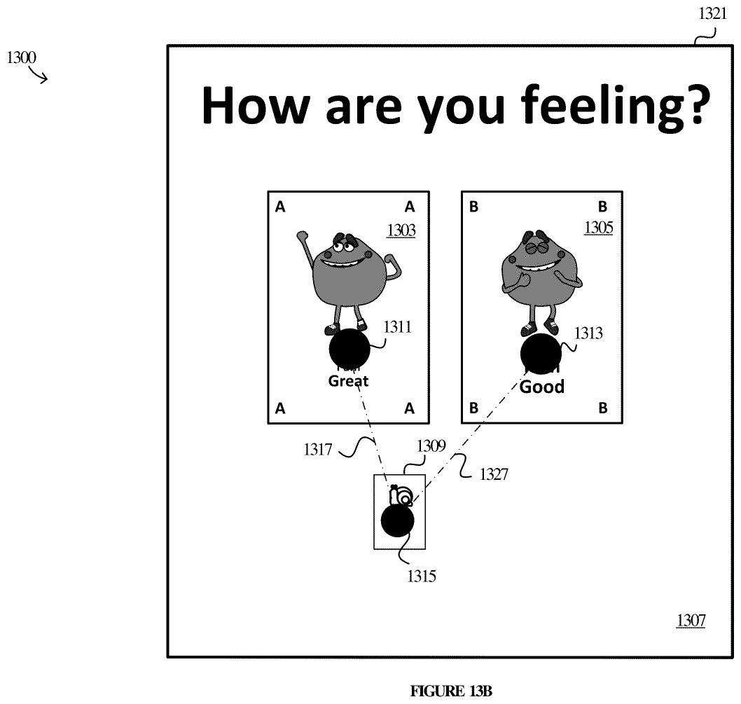

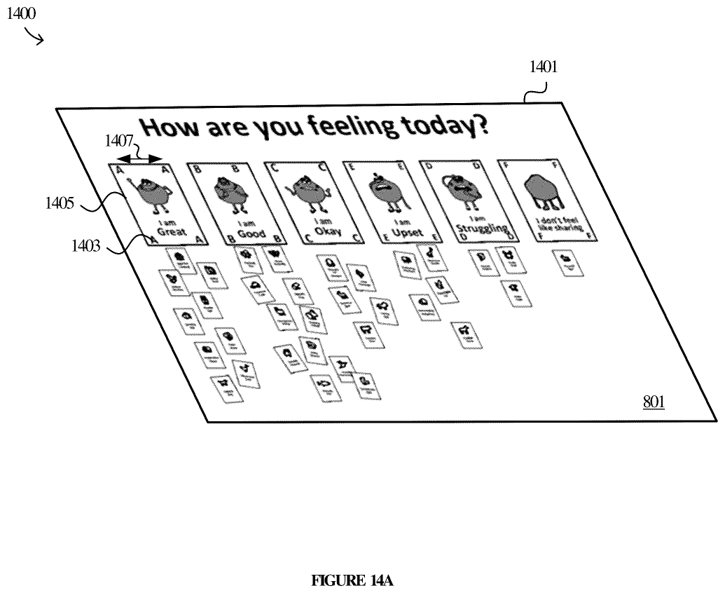

FIGS. 13A-B illustrate brief operational scenarios 1300 in another implementation of image correction process 1100 to identify and correct a detected image distortion. The following describes an application of image correction process 1100 with respect to the elements of operational scenario 1300.

In FIG. 13A, operational scenario 1300 includes image 1301 which depicts a misalignment of polling cards 1303 and 1305 on a canvas of physical polling board 1307, and for clarity, only one response card (i.e., response card 1309). A computing device identifies centroids 1311 and 1313 of polling cards 1303 and 1305, respectively, and centroid 1315 of response card 1309. The computing device further detects a distortion in image 1301, specifically, the misalignment of centroids 1311 and 1313. If the image distortion is not corrected, then the computing device may erroneously group centroid 1315 with centroid 1313 because distance 1317 is longer than distance 1319.

In FIG. 13B, operational scenario 1300 includes image 1321 which depicts a correction of the image distortion detected with respect to FIG. 13A. Here, the computing device aligned centroid 1313 with centroid 1311 (e.g., based on a best fit analysis, a regression analysis that included three or more cards). Then, the computing device calculates distance 1317 between centroids 1311 and 1315 and distance 1327 between centroids 1313 and 1315. Distance 1317 is less than distance 1327; as a result, the computing device correctly groups centroid 1315 with centroid 1311.

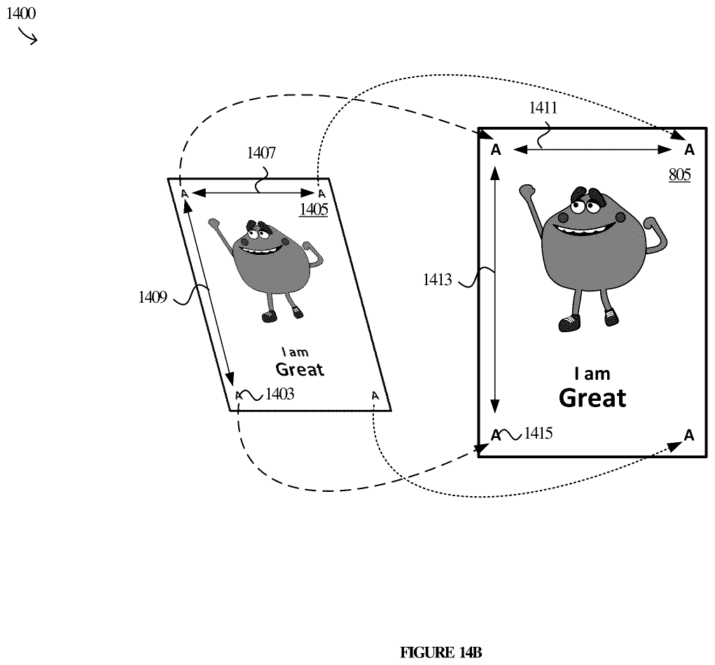

FIGS. 14A-B illustrate another operational scenario 1400 in yet another application of image correction process 1100 to identify and correct a detected image distortion. The following describes an application of image correction process 1100 with respect to the elements of operational scenario 1400.

In FIG. 14A, operational scenario 1400 includes image 1401 which depicts a perspective distortion of physical polling board 801. Here, a computing device detects the perspective distortion by identifying the anchor symbols (e.g., symbol 1403) of the polling cards (e.g., card 1405) and calculates a distance between the anchor symbols (e.g., distance value 1407). The computing device then compares the calculated distance to a known distance of the anchor symbols on the physical polling cards of physical polling board 801 and detects the distortion when the calculated distance differs proportionally from the known distance.

In FIG. 14B, operational scenario 1400 includes card 1405 having distance values 1407 and 1409, and polling card 805, which has known values 1411 and 1413. Distance values 1407 and 1409 were calculated by the computing device based on the location of the anchor symbols of card 1405 (e.g., the location of symbol 1403). Known values 1411 and 1413 were known by the computing device prior to analyzing image 1401.

Here, the computing device corrects the perspective distortion of image 1401 by mapping the anchor symbols of card 1405 (e.g., symbol 1403) to the anchor symbols of polling card 805 (e.g., symbol 1415). As part of the mapping, aspects of image 1401 are manipulated such that distances 1407 and 1409 become proportional to known values 1411 and 1413, respectively.

FIG. 15 illustrates computing device 1501 that is representative of any system or collection of systems in which the various processes, programs, services, and scenarios disclosed herein may be implemented. Examples of computing device 1501 include, but are not limited to, desktop and laptop computers, tablet computers, mobile computers, mobile phones, and wearable devices. Examples may also include server computers, web servers, cloud computing platforms, and data center equipment, as well as any other type of physical or virtual server machine, container, and any variation or combination thereof.

Computing device 1501 may be implemented as a single apparatus, system, or device or may be implemented in a distributed manner as multiple apparatuses, systems, or devices. Computing device 1501 includes, but is not limited to, processing system 1502, storage system 1503, software 1505, communication interface system 1507, and user interface system 1509 (optional). Processing system 1502 is operatively coupled with storage system 1503, communication interface system 1507, and user interface system 1509.

Processing system 1502 loads and executes software 1505 from storage system 1503. Software 1505 includes and implements polling process 1506, which is representative of the polling processes discussed with respect to the preceding Figures, such as polling process 200 and image correction process 1100. When executed by processing system 1502, software 1505 directs processing system 1502 to operate as described herein for at least the various processes, operational scenarios, and sequences discussed in the foregoing implementations. Computing device 1501 may optionally include additional devices, features, or functionality not discussed for purposes of brevity.

Referring still to FIG. 15, processing system 1502 may comprise a micro-processor and other circuitry that retrieves and executes software 1505 from storage system 1503. Processing system 1502 may be implemented within a single processing device but may also be distributed across multiple processing devices or sub-systems that cooperate in executing program instructions. Examples of processing system 1502 include general purpose central processing units, graphical processing units, application specific processors, and logic devices, as well as any other type of processing device, combinations, or variations thereof.

Storage system 1503 may comprise any computer readable storage media readable by processing system 1502 and capable of storing software 1505. Storage system 1503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1503 may also include computer readable communication media over which at least some of software 1505 may be communicated internally or externally. Storage system 1503 may be implemented as a single storage device but may also be implemented across multiple storage devices or sub-systems co-located or distributed relative to each other. Storage system 1503 may comprise additional elements, such as a controller, capable of communicating with processing system 1502 or possibly other systems.

Software 1505 (including polling process 1506) may be implemented in program instructions and among other functions may when executed by processing system 1502, direct processing system 1502 to operate as described with respect to the various operational scenarios, sequences, and processes illustrated herein. For example, software 1505 may include program instructions for implementing a polling process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1505 may include additional processes, programs, or components, such as operating system software, virtualization software, or other application software. Software 1505 may also comprise firmware or some other form of machine-readable processing instructions executable by processing system 1502.

In general, software 1505 may, when loaded into processing system 1502 and executed, transform a suitable apparatus, system, or device (of which computing device 1501 is representative) overall from a general-purpose computing system into a special-purpose computing system customized to support energy efficiency and moderation features, functionality, and user experiences. Indeed, encoding software 1505 on storage system 1503 may transform the physical structure of storage system 1503. The specific transformation of the physical structure may depend on various factors in different implementations of this description. Examples of such factors may include, but are not limited to, the technology used to implement the storage media of storage system 1503 and whether the computer-storage media are characterized as primary or secondary storage, as well as other factors.

For example, if the computer readable storage media are implemented as semiconductor-based memory, software 1505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1507 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of polling applications and services, they apply as well to other contexts such as productivity applications and services, virtual and augmented reality applications and services, business applications and services, and other types of software applications, services, and environments.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive an image of a physical polling board, wherein the physical polling board includes a canvas and response cards of group members arranged on the canvas in proximity to polling cards; and
for at least a response card of the response cards:
identify a position of the response card on the canvas;
identify a polling option corresponding to the position on the canvas;
identify a group member associated with the response card; and
log the polling option in association with the group member.

2. The computing apparatus of claim 1 wherein to identify the polling option corresponding to the position on the canvas, the program instructions direct the computing apparatus to identify a one of the polling cards most proximate to the response card and identify an emotion corresponding to the one of the polling cards.

3. The computing apparatus of claim 1 wherein to identify the group member associated with the response card, the program instructions direct the computing apparatus to look up an identity of the group member in a table having identities of group members stored in association with the response cards.

4. The computing apparatus of claim 3 wherein each of the response cards comprises a physical card attachable to the canvas, and wherein the physical card includes a graphical representation of a character and alphanumeric characters printed on the physical card indicative of a name of the character.

5. The computing apparatus of claim 4 wherein to identify the group member associated with the response card, the program instructions further direct the computing apparatus to perform optical character recognition on a portion of the image that includes the response card to extract the name of the character.

6. The computing apparatus of claim 5 wherein to look up the identity of the group member in the table, the program instructions direct the computing apparatus to look up the response card in the table based on the name of the character.

7. The computing apparatus of claim 1 wherein the program instructions further direct the computing apparatus to generate a report comprising trend data for at least the group member associated with the response card.

8. One or more computer readable storage media having program instructions stored thereon that, when executed by one or more processors, direct a computing apparatus to at least:
receive an image of a physical polling board, wherein the physical polling board includes a canvas and response cards of group members arranged on the canvas in proximity to polling cards; and
for at least a response card of the response cards:
identify a position of the response card on the canvas;
identify a polling option corresponding to the position on the canvas;
identify a group member associated with the response card; and
log the polling option in association with the group member.

9. The one or more computer readable storage media of claim 8 wherein to identify the polling option corresponding to the position on the canvas, the program instructions direct the computing apparatus to identify a one of the polling cards most proximate to the response card and identify an emotion corresponding to the one of the polling cards.

10. The one or more computer readable storage media of claim 8 to identify the group member associated with the response card, the program instructions direct the computing apparatus to look up an identity of the group member in a table having identities of group members stored in association with the response cards.

11. The one or more computer readable storage media of claim 10 wherein each of the response cards comprises a physical card attachable to the canvas, wherein the physical card includes a graphical representation of a character and alphanumeric characters printed on the physical card indicative of a name of the character.

12. The one or more computer readable storage media of claim 11 wherein to identify the group member associated with the response card, the program instructions further direct the computing apparatus to perform optical character recognition on a portion of the image that includes the response card to extract the name of the character.

13. The one or more computer readable storage media of claim 12 wherein to look up the identity of the group member in the table, the program instructions direct the computing apparatus to look up the response card in the table based on the name of the character.

14. The one or more computer readable storage media of claim 8 wherein the program instructions further direct the computing apparatus to generate a user interface comprising trend data for at least the group member associated with the response card.

15. A method comprising:
receiving an image of a physical polling board, wherein the physical polling board includes a canvas and response cards of group members arranged on the canvas in proximity to polling cards; and
for at least a response card of the response cards:
identifying a position of the response card on the canvas;
identifying a polling option corresponding to the position on the canvas;
identifying a group member associated with the response card; and
logging the polling option in association with the group member.

16. The method of claim 15 wherein identifying the polling option corresponding to the position on the canvas comprises identifying a one of the polling cards most proximate to the response card and identify a polling option corresponding to the one of the polling cards.

17. The method of claim 15 wherein identifying the group member associated with the response card comprises looking up an identity of the group member in a table having identities of group members stored in association with the response cards.

18. The method of claim 17 wherein each of the response cards comprises a physical card attachable to the canvas, wherein the physical card includes a graphical representation of a character and alphanumeric characters printed on the physical card indicative of a name of the character.

19. The method of claim 18 wherein identifying the group member associated with the response card comprises performing optical character recognition on a portion of the image that includes the response card to extract the name of the character.

20. The method of claim 19 wherein looking up the identity of the group member in the table comprises looking up the response card in the table based on the name of the character.
